(19) United States
(12) Patent Application Publication
(10) Pub. No.: US 2025/0278342 A1
(43) Pub. Date: Sep. 4, 2025

(54) BUSINESS SERVICE HEALTH SCORE VALIDATION FRAMEWORK

(71) Applicant: Kyndryl, Inc., New York, NY (US)

(72) Inventors: Mouleswara Reddy Chintakunta, Allagadda (IN); Anil Babu Boppanna, Bangalore (IN); Reagan Mitchell, Austin, TX (US)

(21) Appl. No.: 18/592,950

(22) Filed: Mar. 1, 2024

(51) Int. Cl. G06F 11/30

(52) U.S. Cl. CPC G06F 11/302

(57) ABSTRACT

Embodiments receive metric and log data from an external system; generate a first set of health scores for metric data of the metric and log data using a plurality of artificial intelligence (AI) models; generate a second set of health scores for log data of the metric and log data using a log data analysis; determine a similarity score based on the first set of health scores and the second set of health scores; and perform a validation by comparing the similarity score to a predetermined threshold value.

### BACKGROUND

Aspects of the present invention relate generally to a business service health score validation framework and, more particularly, to a system and method for performing multivariate data analysis to validate business service health scores generated from metrics.

Business services are a combination of one or more applications. For example, business service health has a topology structure of resource health and application health. In another example, calculating and validating resource health may help in estimating application and business service health.

### SUMMARY

In a first aspect of the invention, there is a computer-implemented method including: receiving, by a computing device, metric and log data from an external system; generating, by the computing device, a first set of health scores for metric data of the metric and log data using a plurality of artificial intelligence (AI) models; generating, by the computing device, a second set of health scores for log data of the metric and log data using a log data analysis; determining, by the computing device, a similarity score based on the first set of health scores and the second set of health scores; and performing, by the computing device, a validation by comparing the similarity score to a predetermined threshold value.

In another aspect of the invention, there is a computer program product including one or more computer readable storage media having program instructions collectively stored on the one or more computer readable storage media. The program instructions are executable to: receive metric and log data from an external system; generate a first set of health scores for metric data of the metric and log data using a plurality of artificial intelligence (AI) models; generate a second set of health scores for log data of the metric and log data using a log data analysis module; determine a similarity score based on the first set of health scores and the second set of health scores; perform a validation by comparing the similarity score to a predetermined threshold value; and output the first second set of health scores and the second set of health scores and corresponding timestamps to a graphical user interface (GUI).

In another aspect of the invention, there is system including a processor, a computer readable memory, one or more computer readable storage media, and program instructions collectively stored on the one or more computer readable storage media. The program instructions are executable to: receive metric and log data from an external system; generate a first set of health scores for metric data of the metric and log data using a plurality of artificial intelligence (AI) models which include a matrix profile model, a seasonal trend decomposition (STD) model, an elliptic envelop model, and an isolation forest model; generate a second set of health scores for log data of the metric and log data using a textscalar, a graph embedding component, a graph attention network, a spatial short Fourier transform component, and a gated recurrent unit (GRU); determine a similarity score based on the first set of health scores and the second set of health scores; perform a validation by comparing the similarity score to a predetermined threshold value; and output the first second set of health scores and the second set of health scores and corresponding timestamps to a graphical user interface (GUI). The metric data comprises a central processing unit (CPU) utilization, memory utilization, and network bytes.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of a multivariate data analysis system in accordance with aspects of the present invention.

FIG. 5 shows a block diagram of a metric analysis module in accordance with aspects of the present invention.

FIG. 6 shows a block diagram of a log data analysis module in accordance with aspects of the present invention.

FIG. 7 shows another block diagram of the log data analysis module in accordance with aspects of the present invention.

FIG. 8 shows a validation and similarity module in accordance with aspects of the present invention.

FIG. 9 shows a flowchart of an exemplary method in accordance with aspects of the present invention.

### DETAILED DESCRIPTION

Aspects of the present invention relate generally to a business service health score validation framework. In more specific embodiments, aspects of the present invention relate to a system, a method, and/or a computer program for performing multivariate data analysis to validate business service health scores generated from metrics. According to aspects of the invention, the system, a method, and/or a computer program is directed to validating a generated health score of a business service from metrics information and improving accuracy of the generated health score. Further, embodiments of the present invention are directed to explaining the generated health score from the metrics information.

Embodiments of the present invention implement a multi-part framework for identifying anomalies in metrics and log data to generate health scores. Further, implementations of the present invention provide a system, a method, and/or a computer program for validating health scores and comparing the validated health scores to other rule-based functions developed by subject matter experts (SMEs). Aspects of the present invention include an anomaly detection framework which generates a health score from multivariate metrics data.

Embodiments of the present invention provide an improved understanding of a health impact of a resource, an application, and a business service. Further, aspects of the present invention provide an influence path of each resource, which can help in customer retention and satisfaction. Implementations of the present invention provide a scalable and cost-effective solution for a large and diverse set of customers which have rapid innovation and changes in the marketplace and competitive landscape. Embodiments of the present invention provide an accurate health score which helps in alerting businesses to any persistent issues within a predetermined timeframe (e.g., within the next twenty four hours). Further embodiments of the present invention provide centralized visibility into disparate services and an overall system health. Aspects of the present invention provide predictive health scores which enables pre-emptive and proactive business decisions to ensure there are minimal business incidents. Implementations of the present invention also identify a top health influence of a resource and an application of a business service health and uses the top health influence for future forecasting and explainability. In addition, embodiments of the present invention may be directed to an explainable model stack.

In more specific embodiments of the present invention, the system, method, and/or computer program provides an artificial intelligence (AI) based multivariate analysis on unstructured data to return a relationship between unstructured log files and their weightage while determining the health score. The system, method, and/or computer program of the present invention also provides an AI driven health score generator from multivariate unstructured data, which will return the health score from log data sources. Also, implementations of the present invention provide a system, a method, and/or a computer program to return a similarity between captured health scores.

According to an aspect of the invention, a computer-implemented method includes: measuring an anomaly detection framework which generates a health score from multivariate metrics data; performing an artificial intelligence (AI) based multivariate analysis on unstructured data to return a relationship between unstructured log files and their weightage while determining the health score; an AI driven health score module which generates an AI driven health score from multivariate unstructured data, which will return the health score from log data sources; and returning a similarity between captured health scores.

Accordingly, implementations of the present invention provide an improvement in the technical field of multivariate data analysis by generating and validating accurate health scores. Generating and validating health scores can be provided by identifying anomalies in metric and log data to generate health scores and validating the generated health scores by determining a similarity score between the generated health scores. In contrast, known systems are not able to directly determine system health scores, analyze multivariate unstructured data, and validate the determined system health scores. Accordingly, known systems have difficulty in determining an application and a health of a system, e.g., memory utilization of the system.

Implementations of the present invention are necessarily rooted in computer technology. For example, the step of providing an artificial intelligence (AI) based multivariate model on unstructured data to determine a health score is computer-based and cannot be performed in the human mind. Training and building the AI based multivariate model is, by definition, performed by a computer and cannot practically be performed in the human mind (or with pen and paper) due to the complexity and massive amounts of calculations involved. For example, training and building the AI based multivariate model will use a plurality of AI algorithms to determine a health score and validate the health score using similarity scoring, as an example. In particular, training and building the AI based multivariate model performs a large amount of processing of the unstructured data and modeling of parameters to train the AI based multivariate model such that an output of the AI based multivariate model is generated and outputted in real time (or near real time). In other words, the AI based multivariate model is trained using a large amount of previously captured unstructured data and other parameters such that the AI based multivariate model is configured to output health scores in real-time. Given the scale and complexity of processing captured unstructured data and modeling of parameters, it is simply not possible for the human mind, or for a person using pen and paper, to perform the number of calculations involved in training and/or building the AI based multivariate model.

It should be understood that, to the extent implementations of the invention collect, store, or employ personal information provided by, or obtained from, individuals (for example, users of multivariate metrics data), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

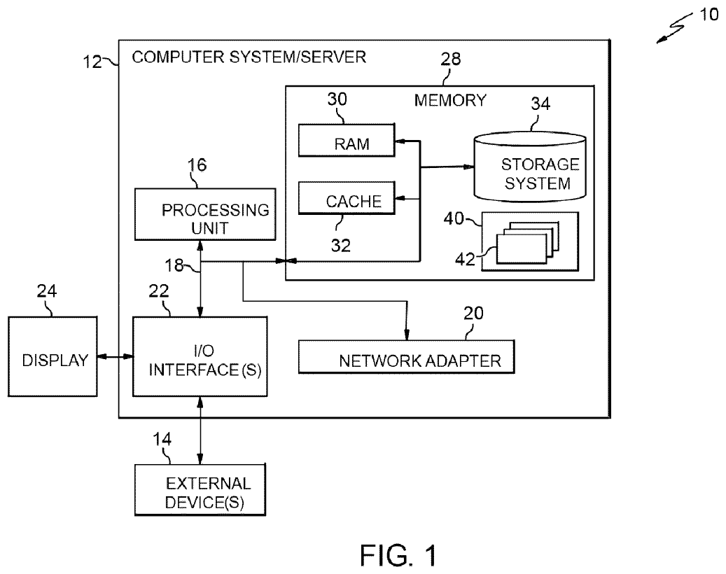

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand- held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

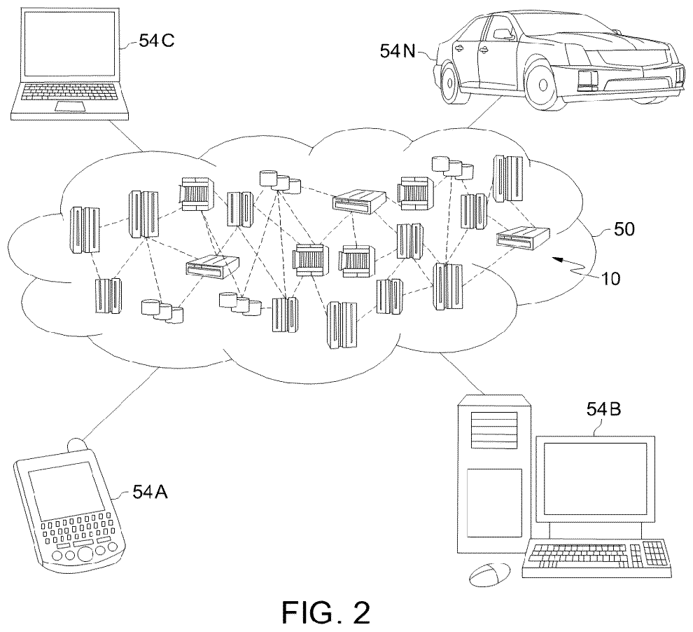

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

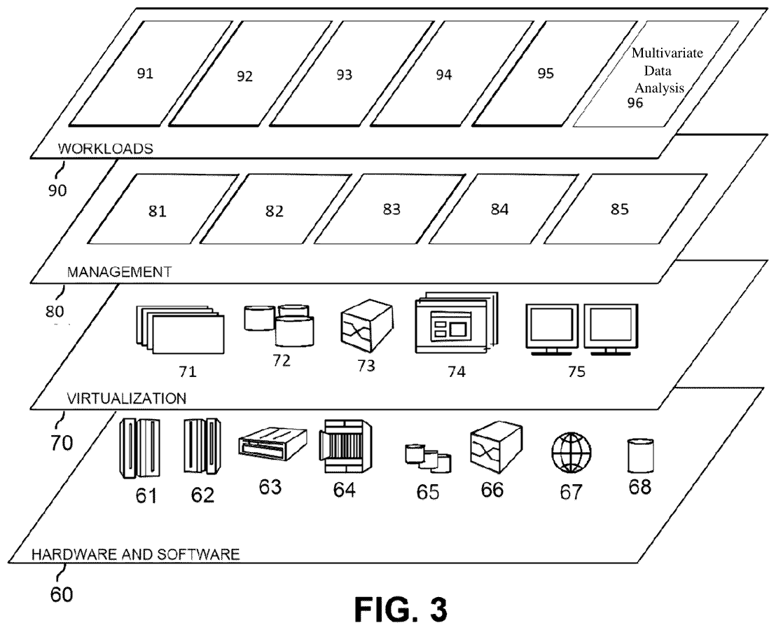

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and multivariate data analysis 96.

Implementations of the invention may include a computer system/server 12 of FIG. 1 in which one or more of the program modules 42 are configured to perform (or cause the computer system/server 12 to perform) one of more functions of the multivariate data analysis 96 of FIG. 3. For example, the one or more of the program modules 42 may be configured to: receive metric and log data from an external system; generate a first set of health scores for metric data of the metric and log data using a plurality of artificial intelligence (AI) models which include a matrix profile model, a seasonal trend decomposition (STD) model, an elliptic envelop model, and an isolation forest model; generate a second set of health scores for log data of the metric and log data using a textscalar, a graph embedding component, a graph attention network, a spatial short Fourier transform component, and a gated recurrent unit (GRU); determine a similarity score based on the first set of health scores and the second set of health scores; and perform a validation by comparing the similarity score to a predetermined threshold value.

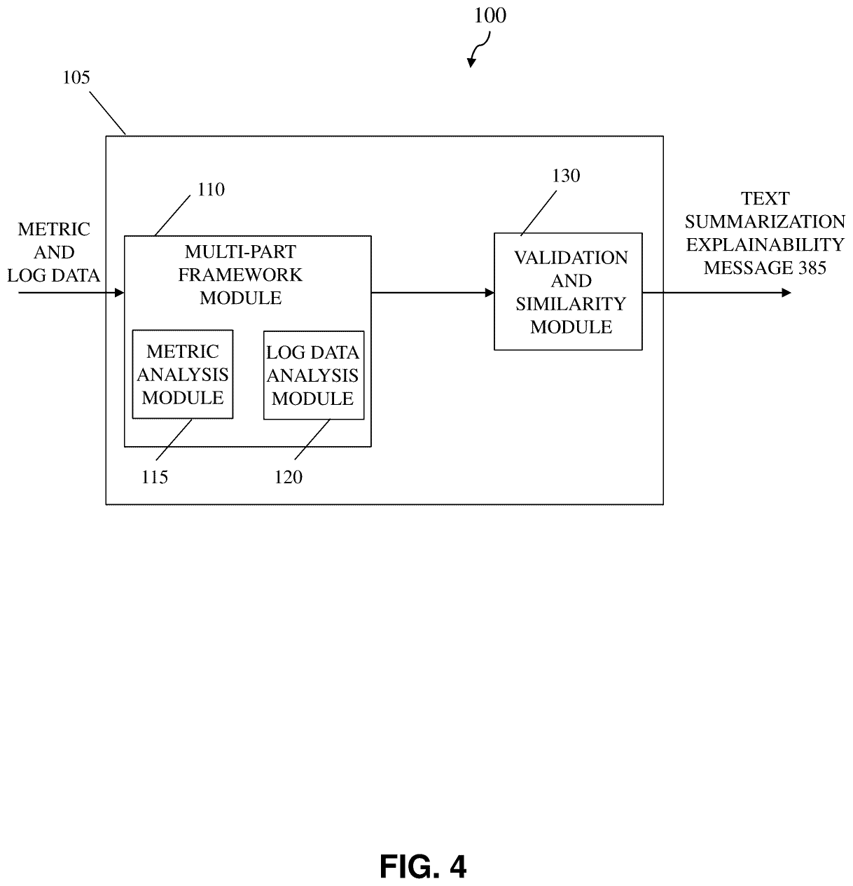

FIG. 4 shows a block diagram of an attack detection system in accordance with aspects of the invention. In embodiments, the multivariate data analysis system 100 comprises a multivariate data analysis environment 105 which includes a multi-part framework module 110, a metric analysis module 115, a log data analysis module 120, and a validation and similarity module 130, each of which may comprise one or more program modules such as program modules 42 described with respect to FIG. 1 and the multivariate data analysis 96 of FIG. 3.

The multivariate data analysis system 100 may include additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

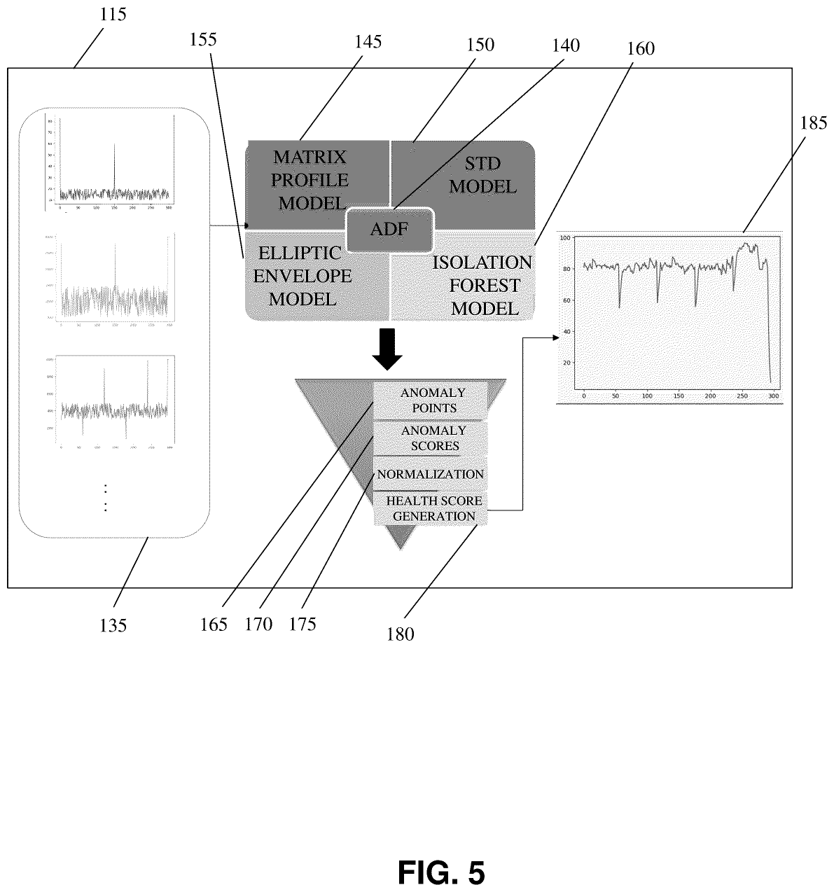

In embodiments of FIG. 4, the multi-part framework module 110 receives metric and log data from an external system. In embodiments, the multi-part framework module 110 comprises a metric analysis module 115 which performs AI based multivariate analysis on unstructured metric data to determine a first set of health scores. In further embodiments, the multi-part framework module 110 comprises a log data analysis module 120 which performs AI based multivariate analysis on unstructured log data to determine a second set of health scores. In embodiments, the muti-part framework module 110 outputs the first set of health scores and the second set of health scores to the validation and similarity module 130. Details of the metric analysis module 115 and the log data analysis module 120 are provided in FIGS. 5-7.

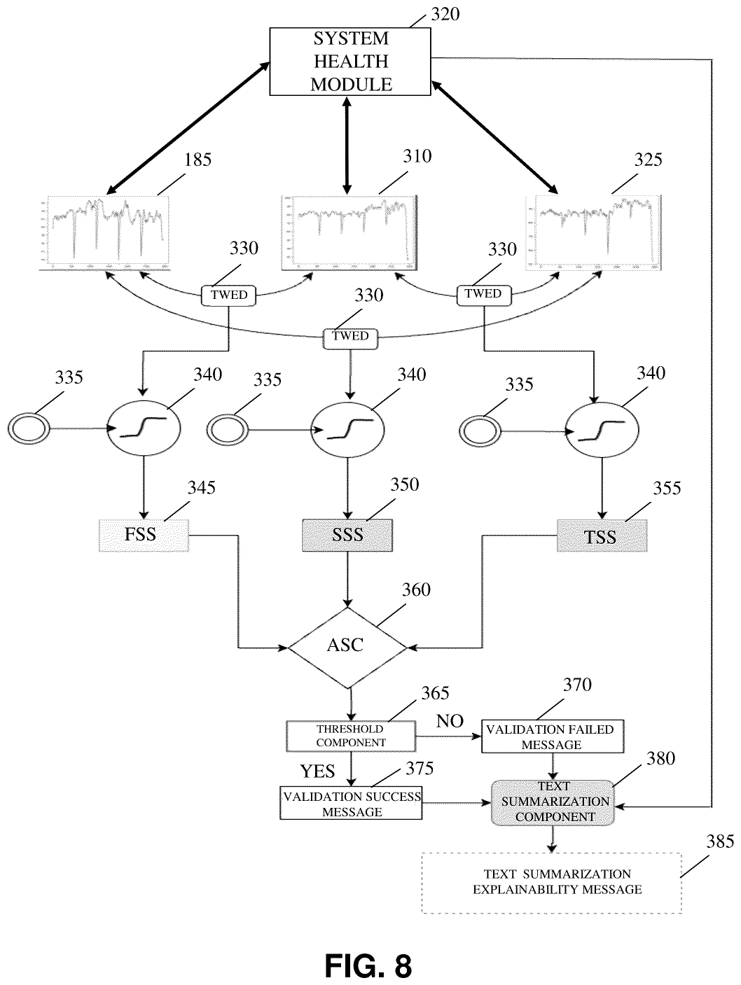

In embodiments of FIG. 4, the validation and similarity module 130 receives the first set of health scores and the second set of health scores. In embodiments, the validation and similarity module 130 validates the first and second set of health scores and outputs a similarity score between the first and second set of health scores. In further embodiments, the validation and similarity module 130 also receives a third set of health scores from rule-based functions developed by subject matter experts (SMEs). In this scenario, the validating and similarity module 130 validates the first and third set of health scores and outputs a similarity score between the first and third set of health scores. Further, the validating and similarity module 130 validates the second and third set of health scores and outputs a similarity score between the second and third set of health scores. Moreover, the validating and similarity module 130 validates the first and second set of health scores and outputs a similarity score between the first and second set of health scores. In embodiments, the validation and similarity module 130 outputs a text summarization explainability message 385 to an external system (see FIG. 8). Details of the validation and similarity module 130 are provided in FIG. 8.

FIG. 5 shows a block diagram of a metric analysis module in accordance with aspects of the present invention. In embodiments, the metric analysis module 115 receives the unstructured metric data 135 and then inputs the unstructured metric data to an anomaly detection framework (ADF) 140. In embodiments, the unstructured metric data 135 comprises unstructured multivariate metric data such as a central processing unit (CPU) utilization, memory utilization, network bytes, etc. The ADF 140 comprises a unified framework which is utilized for an application of a computing device. In further embodiments, the ADF 140 comprises a plurality of AI models including a matrix profile model 145, a seasonal trend decomposition (STD) model 150, an elliptic envelop model 155, and isolation forest model 160.

In embodiments of FIG. 5, the matrix profile model 145 of the ADF 140 receives the unstructured metric data 135 and calculates anomaly points and anomaly scores using a matrix profile algorithm which computes distances for a windowed sub-sequence against an entire time series, sets an exclusion zone to ignore trivial matches, updates a distance profile with minimal values, and sets a first nearest-neighbor index. In further embodiments, the STD model 150 of the ADF 140 receives the unstructured metric data 135 and calculates anomaly points and anomaly scores using a STD algorithm, which uses locally fitted regression models to decompose a time series into trend, seasonal, and remainder components. The elliptic envelop model 155 of the ADF 140 receives the unstructured metric data 135 and calculates anomaly points and anomaly scores using an elliptic envelop algorithm, which creates an elliptical area around a dataset of the unstructured metric data 135. In further implementations of the present invention, the isolation forest model 160 of the ADF 140 receives the unstructured metric data 135 and calculates anomaly points and anomaly scores using an isolation forest algorithm, which splits a data space randomly and uses a randomly selected attribute and a randomly selected split point to detect anomalies. The ADF 140 will output an intersection of all anomaly points 165 and corresponding anomaly scores 170 from the matrix profile model 145, the STD model 150, the elliptic envelop model 155, and the isolation forest model 160.

In further embodiments of FIG. 5, the corresponding anomaly scores 170 are normalized 175. After normalization 175, the normalized anomaly scores are used in a health score generation 180 to generate health scores 185. Accordingly, the health score generation 180 outputs the health scores 185 of the health of a business service.

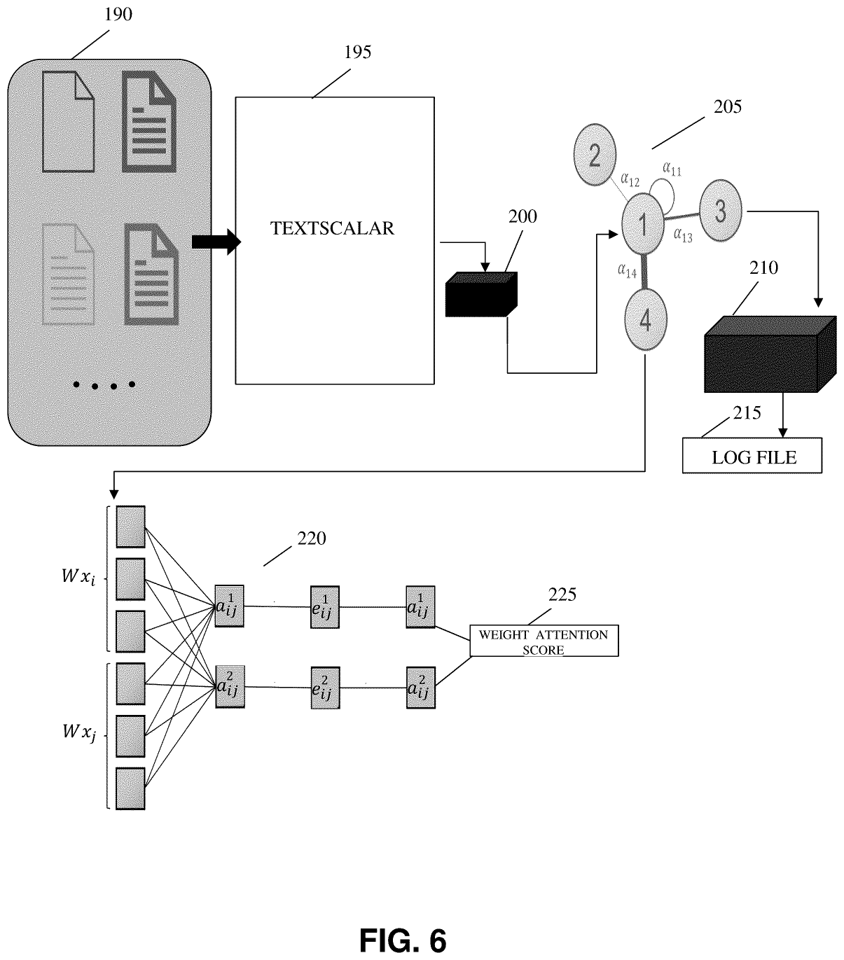

FIG. 6 shows a block diagram of a log data analysis module in accordance with aspects of the present invention. In embodiments, the log data analysis module 120 receives the unstructured log data 190 and sends the unstructured log data 190 to a textscalar 195. In embodiments, the textscalar 195 converts each log at a specific timestamp of the unstructured log data 190 to a scalar value and multiplies the converted scalar value to create row vectors per log file. In embodiments, the row vectors per log file are sent to a graph embedding component 200. The graph embedding component 200 receives the row vectors per log file and uses a neural network (NN) algorithm to return graph data which includes links between log files based on their Euclidean distance. In embodiments, the graph embedding component 200 sends the graph data comprising the links between log files based on their Euclidean distance to a graph neural network (GNN) 205. The GNN 205 receives the graph data and generates node embedding vectors which comprise vectors that represent the Euclidean distance and other similarity characteristics between the nodes in the graph data. The GNN 205 sends the generated node embedding vectors to an eigenvector centrality component 210 and a graph attention network (GAT) 220.

In embodiments of FIG. 6, the eigenvector centrality component 210 receives the generated node embedding vectors and determines a weightage of each log file 215 by using an eigenvector centrality algorithm to measure a transitive influence of nodes based on relationships originating from high-scoring nodes which contribute more to the score of a node than connections from low-scoring nodes. In further embodiments, the GAT 220 finds a relationship between the log files by passing two node embedding vectors (i.e., Wxᵢ, Wxⱼ) at a time to output a weight attention score 225. In embodiments, the weight attention score 225 comprises a relationship between nodes. The GAT 220 performs the above operation for all possible combination of nodes.

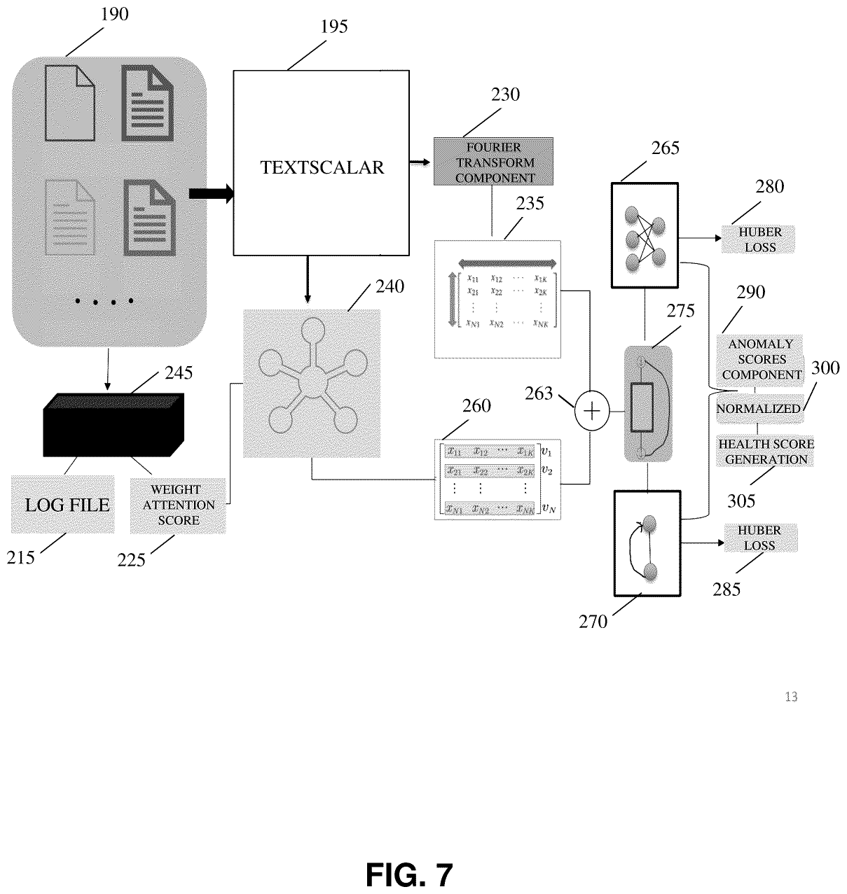

FIG. 7 shows another block diagram of the log data analysis module in accordance with aspects of the present invention. In embodiments, the log data analysis module 120 receives the unstructured log data 190 and sends the unstructured log data 190 to the textscalar 195. In embodiments, the textscalar 195 converts each log at a specific timestamp of the unstructured log data 190 to a scalar value and multiplies the converted scalar value to create row vectors per log file. The textscalar 195 converts the row vectors per log file into a matrix. The textscalar 195 sends the matrix to a spatial short Fourier transform component 230 and another graph attention network (GAT) 240.

In embodiments of FIG. 7, the spatial short Fourier transform component 230 receives the matrix and converts the matrix into a spatial dimension and temporal dimension of a lower space 235. The GAT 240 will receive the weightage of each log file 215 and the weight attention score 225 from a multivariate analysis 245 using the log data analysis module 120 of FIG. 6. As described above in FIG. 6, the weight attention score 225 comprises the relationship between nodes. The GAT 240 will output a matrix 260 based the weightage of each log file 215, the weight attention score 225, and the matrix from the textscalar 195 using learning attention functions that assign weights to nodes in a graph and allow different nodes to have varying influences during the feature aggregation process. The GAT 240 sends the matrix 260 to be concatenated with the spatial dimension and temporal dimension of the lower space 235 at a concatenation operator module 263. The concatenated matrix is sent by the concatenation operator module 263 to a gated recurrent unit (GRU) 275.

In embodiments of FIG. 7, the GRU 275 comprises a gating mechanism in recurrent neural networks to input or forget certain features. In particular, the GRU 275 outputs the concatenated matrix which comprises a concatenation of the matrix 260 and the spatial dimension and temporal dimension of the lower space 235 to a forecasting based model 265. The forecasting model 265 returns forecasted anomaly scores and averages the forecasted anomaly scores with a huber loss 280. The forecasting based model 265 sends the averaged forecasted anomaly scores after the huber loss to the anomaly scores component 290. The GRU 275 also outputs the concatenated matrix to a reconstruction based model 270. The reconstruction based model 270 returns reconstructed anomaly scores and averages the reconstructed anomaly scores with another huber loss 285. In further embodiments, the reconstruction based model 270 receives the concatenated matrix and assigns a reconstructed anomaly score to each object in the concatenated matrix based on a similarity of each object to an overall data in the concatenated matrix. The reconstruction based model 270 sends the averaged reconstructed anomaly scores after the huber loss to the anomaly scores component 290.

In further embodiments of FIG. 7, the anomaly scores component 290 generates final anomaly scores based on the average of the reconstructed anomaly scores after the huber loss and the averaged forecasted anomaly scores after the huber loss. In embodiments, the huber loss comprises a loss function which makes the average of the reconstructed anomaly scores and the average forecasted anomaly scores less sensitive to outlier anomalies and minimizes errors within the average of the reconstructed anomaly scores and the average forecasted anomaly scores. Then, the generated final anomaly scores are normalized 300. In embodiments, the generated final anomaly scores are normalized 300 by scaling the generated final anomaly scores in a range of 0 to 100, in which 100 represents a highest anomaly score and 0 represents a lowest anomaly score. After the normalization 300, the normalized final anomaly scores are used in a health score generation 305 to generate health scores 310 (as shown in FIG. 8). Accordingly, the health score generation 305 outputs the health scores 310 of the business service health.

FIG. 8 shows a validation and similarity module in accordance with aspects of the present invention. In embodiments, the validation and similarity module 130 includes a system health module 320 which receives the health scores 185 corresponding to the unstructured metric data 135, the health scores 310 corresponding to the unstructured log data 190, and health scores 325 from rule-based functions. In aspects of the present invention, the system health module 320 also receives timestamps corresponding to the health scores 185, 310, and 325. In further embodiments, the health scores 325 may be determined based on rule-based functions developed by SMEs; however, embodiments are not limited to this example. For example, the system health 320 may only receive the health scores 185 corresponding to the unstructured metric data 135 and the health scores 310 corresponding to the unstructured log data 190.

In embodiments of FIG. 8, a time wrapped edit distance (TWED) component 330 measures a similarity between the health scores 185 and the health scores 310, a similarity between the health scores 185 and the health scores 325, and a similarity between the health scores 310 and the health scores 325 using a discrete time series matching algorithm with time elasticity. In particular, the time wrapped edit distance component 300 uses the discrete time series matching algorithm with time elasticity to quantify how similar the health scores are to each other by counting a minimum number of operations required to transform one of the health scores to the other health score. In aspects of the present invention, the time wrapped edit distance (TWED) component 330 outputs the similarity between the health scores 185 and the health scores 310, the similarity between the health scores 185 and the health scores 325, and the similarity between the health scores 310 and the health scores 325 to a sigmoid activation function 340. The sigmoid activation function 340 receives a bias input 335 from a deep learning model and outputs a first similarity score (FSS) 345 corresponding to the similarity between the health scores 185 and the health score 325, a second similarity score (SSS) 350 corresponding to the similarity between the health scores 185 and the health scores 325, and a third similarity score (TSS) 355 corresponding to the similarity between the health scores 310 and the health scores 325 to an average similarity score (ASC) component 360. The bias input 335 is a constant value from the deep learning model that allows a shifting of the sigmoid activation function 340 towards predetermined output values.

In further embodiments of FIG. 8, the first similarity score (FSS) 345, the second similarity score (SSS) 350, and the third similarity score (TSS) 355 are a numerical value between a range of zero (e.g., no similarity) and one (absolute match in similarity). The average similarity score component (ASC) 360 then averages the first similarity score (FSS) 345, the second similarity score (SSS) 350, and the third similarity score (TSS) 355 together and outputs an averaged similarity score to a threshold component 365. In embodiments, the threshold component 365 compares the averaged similarity score to a predetermined threshold value. The threshold component 365 outputs a validation failed message 370 in response to the average similarity score being less than the predetermined threshold value and sends the average similarity score and the validation failed message to a text summarization component 380.

Still referring to FIG. 8, the threshold component 365 outputs a validation success message 375 in response to the average similarity score being greater than the predetermined threshold value and sends the average similarity score and the validation successful message to the text summarization component 380. The text summarization component 380 receives the average similarity score, one of the validation failed message 370 and the validation success message 375, the health scores 185, 310, and 325 and corresponding timestamps from the system health module 320. The text summarization component 380 outputs a text summarization explainability message 385 to a graphical user input (GUI) of a display which includes values of the average similarity score, the health scores 185, 310, and 325 and corresponding timestamps, and a validation message which includes one of the validation failed message 370 and the validation success message 375.

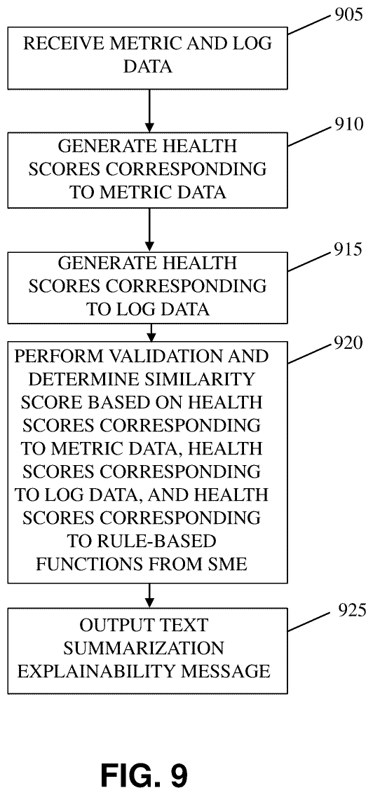

FIG. 9 shows a flowchart of an exemplary method in accordance with aspects of the present invention. Steps of the method may be carried out in the environment of FIGS. 4-8 and are described with reference to elements depicted in FIGS. 4-8.

At step 905, the system receives, at the multi-framework module 110, metric and log data from an external system. In embodiments, and as described with respect to FIG. 4, the multi-framework module 110 further comprises a metric analysis module 115 and a log data analysis module 120.

At step 910, the system generates, at the metric analysis module 115, health scores 185 corresponding to unstructured metric data 135. In embodiments, and as described with respect to FIGS. 4-8, the metric analysis module 115 generates the health scores 185 using an anomaly detection framework (ADF) 140 which comprises a plurality of AI models including a matrix profile model 145, a seasonal trend decomposition (STD) model 150, an elliptic envelop model 155, and an isolation forest model 160. In an example, a health score represents a health of a system, e.g., memory utilization of the system.

At step 915, the system generates, at the log data analysis module 120, health scores 310 corresponding to unstructured log data 190. In embodiments, and as described with respect to FIGS. 4-8, the log data analysis module 120 generates the health scores 310 using a textscalar 195, a graph embedding component 200, at least one of graph attention networks (GATs) 220, 240, a spatial short Fourier transform component 230, and a gated recurrent unit (GRU) 275.

At step 920, the system performs, at the validation and similarity module 130, a validation based on the health scores 185 corresponding to unstructured metric data 135, the health scores 310 corresponding to the unstructured log data 190, and the health scores 325 corresponding to rule-based functions developed by SMEs. In embodiments, and as described with respect to FIGS. 4-8, the validation and similarity module 130 also determines a similarity score between the health scores 185, the health scores 310, and the health scores 325. In further embodiments, and as described with respect to FIG. 4-8, the validation and similarity module 130 performs the validation by comparing the similarity score with a predetermined threshold value.

At step 925, the system outputs, at the validation and similarity module 130, a text summarization explainability message 385 to a graphical user input (GUI) of a display. In embodiments, and as described with respect to FIGS. 4-8, the validation and similarity module 130 outputs the text summarization explainability message 385 which includes values of the similarity scores, the health scores 185, 310, 325 and corresponding timestamps, and a validation message which includes one of the validation failed message 370 and the validation success message 375 in response to a determination of whether the validation was successful.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving, by a computing device, metric and log data from an external system;
generating, by the computing device, a first set of health scores for metric data of the metric and log data using a plurality of artificial intelligence (AI) models;
generating, by the computing device, a second set of health scores for log data of the metric and log data using a log data analysis;
determining, by the computing device, a similarity score based on the first set of health scores and the second set of health scores; and
performing, by the computing device, a validation by comparing the similarity score to a predetermined threshold value.

2. The method of claim 1, wherein the metric data comprises at least one of a central processing unit (CPU) utilization, memory utilization, and network bytes.

3. The method of claim 1, further comprising outputting, by the computing device, a validation failed message in response to the similarity score being less than the predetermined threshold value.

4. The method of claim 1, further comprising outputting, by the computing device, a validation successful message in response to the similarity score being greater than the predetermined threshold value.

5. The method of claim 1, wherein the determining the similarity score based on the first set of health scores and the second set of health scores occurs by using a time wrapped edit distance component between the first set of health scores and the second set of health scores.

6. The method of claim 1, wherein the matrix profile model receives the metric data and calculates anomaly points and anomaly scores using a matrix profile algorithm which computes distances for a windowed sub-sequence against an entire time series, sets an exclusion zone to ignore trivial matches, updates a distance profile with minimal values, and sets a first nearest-neighbor index.

7. The method of claim 1, wherein the seasonal trend decomposition (STD) model receives the metric data and calculates anomaly points and anomaly scores using a STD algorithm which uses locally fitted regression models to decompose a time series into trend, seasonal, and remainder components.

8. The method of claim 1, wherein the elliptic envelop model receives the metric data and calculates anomaly points and anomaly scores using an elliptic envelop algorithm which creates an elliptical area around a dataset of the metric data.

9. The method of claim 1, wherein the isolation forest model receives the metric data and calculates anomaly points and anomaly scores using an isolation forest algorithm which splits a data space randomly and uses a randomly selected attribute and a randomly selected split point to detect anomalies.

10. The method of claim 1, further comprising:
generating, by the computing device, a third set of health scores from rule based functions developed by subject matter expert (SME) rules;
determining, by the computing device, a second similarity score based on the first set of health scores and the third set of health scores;
determining, by the computing device, a third similarity score based on the second set of health scores and the third set of health scores;
averaging, by the computing device, the similarity score, the second similarity score, and the third similarity score together to create an average similarity score; and
validating, by the computing device, the average similarity score by comparing the average similarity score to the predetermined threshold value.

11. The method of claim 1, further comprising outputting, by the computing device, the first set of health scores and the second set of health scores and corresponding timestamps.

12. The method of claim 1, wherein the plurality of AI models comprise a matrix profile model, a seasonal trend decomposition (STD) model, an elliptic envelope model, and an isolation forest model.

13. The method of claim 12, wherein the matrix profile model receives the metric data and calculates a first set of anomaly points and anomaly scores using a matrix profile algorithm which computes distances for a windowed sub-sequence against an entire time series, sets an exclusion zone to ignore trivial matches, and updates a distance profile with minimal values, and sets a nearest-neighbor index, and the STD model receives the metric data and calculates a second set of anomaly points and anomaly scores using a STD algorithm which uses locally fitted regression models to decompose a time series into trend, seasonal, and remainder components.

14. The method of claim 12, wherein the elliptic envelop model receives the metric data and calculates a third set of anomaly points and anomaly scores using an elliptic envelop algorithm which creates an elliptical area around a dataset of the metric data, and the isolation forest model receives the metric data and calculates a fourth set of anomaly points and anomaly scores using an isolation forest algorithm which splits a data space randomly and uses a randomly selected attribute and a randomly selected split point to detect anomalies.

15. The method of claim 1, wherein the log data analysis comprises:
a textscalar which converts each log at a specific timestamp of the log data to a scalar value and multiples the converted scalar value to create row vectors per file;
a graph embedding component which receives the row vectors per file and uses a neural network (NN) algorithm to return links between log files based on their Euclidean distance;
a graph attention network which receives graph data comprising the links between the log files based on their Euclidean distance and generates node embedding vectors;
a spatial short Fourier transform component which receives a matrix based on the row vector per file and converts the matrix into a spatial dimension and temporal dimension of a lower space; and
a gated recurrent unit (GRU) which outputs a concatenated matrix which is a concatenation of the spatial dimension and temporal dimension of the lower space and another matrix based on a weightage of the log file.

16. A computer program product comprising one or more computer readable storage media having program instructions collectively stored on the one or more computer readable storage media, the program instructions executable to:
receive metric and log data from an external system;
generate a first set of health scores for metric data of the metric and log data using a plurality of artificial intelligence (AI) models;
generate a second set of health scores for log data of the metric and log data using a log data analysis module;
determine a similarity score based on the first set of health scores and the second set of health scores;
perform a validation by comparing the similarity score to a predetermined threshold value; and
output the first set of health scores and the second set of health scores and corresponding timestamps to a graphical user interface (GUI).

17. The computer program product of claim 16, further comprising:
outputting a validation failed message in response to the similarity score being less than the predetermined threshold value; and
outputting a validation successful message in response to the similarity score being greater than the predetermined threshold value,
wherein the metric data comprises a central processing unit (CPU) utilization, memory utilization, and network bytes, and the determining the similarity score based on the first set of health scores and the second set of health scores occurs by using a time wrapped edit distance component between the first set of health scores and the second set of health scores.

18. The computer program product of claim 16, wherein the log data analysis module comprises:
a textscalar which converts each log at a specific timestamp of the log data to a scalar value and multiples the converted scalar value to create row vectors per file;
a graph embedding component which receives the row vectors per file and uses a neural network (NN) algorithm to return links between log files based on their Euclidean distance;
a graph attention network which receives graph data comprising the links between the log files based on their Euclidean distance and generates node embedding vectors;
a spatial short Fourier transform component which receives a matrix based on the row vector per file and converts the matrix into a spatial dimension and temporal dimension of a lower space; and
a gated recurrent unit (GRU) which outputs a concatenated matrix which is a concatenation of the spatial dimension and temporal dimension of the lower space and another matrix based on a weightage of the log file.

19. The computer program product of claim 16, wherein the plurality of AI models comprise:
a matrix profile model which receives the metric data and calculates a first set of anomaly points and anomaly scores using a matrix profile algorithm which computes distances for a windowed sub-sequence against an entire time series, sets an exclusion zone to ignore trivial matches, and updates a distance profile with minimal values, and sets a nearest-neighbor index;
a STD model which receives the metric data and calculates a second set of anomaly points and anomaly scores using a STD algorithm which uses locally fitted regression models to decompose a time series into trend, seasonal, and remainder components;
an elliptic envelop model which receives the metric data and calculates a third set of anomaly points and anomaly scores using an elliptic envelop algorithm which creates an elliptical area around a dataset of the metric data; and
an isolation forest model which receives the metric data and calculates a fourth set of anomaly points and anomaly scores using an isolation forest algorithm which splits a data space randomly and uses a randomly selected attribute and a randomly selected split point to detect anomalies.

20. A system comprising:
a processor, a computer readable memory, one or more computer readable storage media, and program instructions collectively stored on the one or more computer readable storage media, the program instructions executable to:
receive metric and log data from an external system;
generate a first set of health scores for metric data of the metric and log data using a plurality of artificial intelligence (AI) models which include a matrix profile model, a seasonal trend decomposition (STD) model, an elliptic envelop model, and an isolation forest model;
generate a second set of health scores for log data of the metric and log data using a textscalar, a graph embedding component, a graph attention network, a spatial short Fourier transform component, and a gated recurrent unit (GRU);
determine a similarity score based on the first set of health scores and the second set of health scores;
perform a validation by comparing the similarity score to a predetermined threshold value; and
output the first set of health scores and the second set of health scores and corresponding timestamps to a graphical user interface (GUI),
wherein the metric data comprises a central processing unit (CPU) utilization, memory utilization, and network bytes.
